(19) United States
(12) Patent Application Publication
(10) Pub. No.: US 2022/0357776 A1
(43) Pub. Date: Nov. 10, 2022

(54) INFORMATION HANDLING SYSTEM MOTORIZED HINGE DUAL CLUTCH

(71) Applicant: Dell Products L.P., Round Rock, TX (US)

(72) Inventors: John Trevor Morrison, Round Rock, TX (US); Jace W. Files, Round Rock, TX (US)

(73) Assignee: Dell Products L.P., Round Rock, TX (US)

(21) Appl. No.: 17/315,924

(22) Filed: May 10, 2021

(51) Int. Cl. G06F 1/16; F16D 13/24

(52) U.S. Cl. CPC G06F 1/1681; F16D 13/24; G06F 1/1637

(57) ABSTRACT

A portable information handling system includes a motorized hinge that rotates first and second housing portions between open and closed positions and a clutch hinge that manages torque during rotation of the first and second housing portions. A clutch of the clutch hinge couples to an axle with a compressive mechanism and a clamping mechanism that combine to apply a total torque that resists rotation of the first and second housing portions. The clamping mechanism couples to the axle from within a clutch housing and the compressive mechanism inserts over the axle to compress at opposing sides of the clutch housing.

### BACKGROUND OF THE INVENTION

### Field of the Invention

The present invention relates in general to the field of portable information handling systems, and more particularly to an information handling system motorized dual clutch.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Convertible information handling systems typically include multiple separate housing portions that couple to each other so that the system converts between closed and open positions. For example, a main housing portion integrates processing components and a keyboard and rotationally couples with hinges to a lid housing portion that integrates a display. In a clamshell position, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

Conventionally, portable information handling systems have had limited capabilities relative to desktop and other fixed systems due to the limited housing interior, which constrains power and thermal management. More recently, powerful and efficient processing components have come to market that have increased the capabilities of portable systems. In particular, gamers have adopted such portable systems as an option for having gaming capability when mobile. These systems tend to have a larger footprint and weight than enterprise or consumer portable systems, however, gamers appreciate the additional capabilities resulting in increased adoption of such gaming portable systems by the community. Such high end portable systems tend to include greater flexibility for personalization by the end user, such as with high performance graphics and memory. Gamers have an affinity for specialized features that stand out, such as a motorized hinge that automatically transitions the housing between open and closed positions.

One difficulty with a motorized hinge is that gaming portable systems tend to have more heavy housing portions. For example, a lid housing portion might weigh in excess of two kilograms. In order to rotate a housing with that weight, the motor, encoder and hinge assembly tends to have a substantial size that can consume all available space on one side of the housing. Such as large assembly and ID constraints can limit the width of the hinge, making integration of a motorized hinge a challenge.

Generally, information handling system hinges, whether or not motorized, tend to include a clutch (a gripping forced) that generates torque to resist rotation of the housing. Torque generation provides a smoother hinge rotation and helps keep the housing in a fixed position when a desired open or close configuration is achieved. One common torque generator is a set of Belleville washers in alternating series around a shaft that creates friction normal to a rotating shaft. Advantages of this approach are low cost and a simple adjustment of torque levels by tightening a bolt that compresses the washers. A disadvantage of this approach is a degradation of torque over time as friction wears the washer surfaces. Another less common torque generator is a clamping force around the shaft by using a wrap design “roll pin” or spring clips. An advantage of this approach is a slower degradation of torque over time, however, such clamping forces are more difficult to calibrate at manufacture. Wide values in torque can impact the effectiveness and life of a motorized hinge.

### SUMMARY OF THE INVENTION

Therefore, a need has arisen for a system and method which manages an information handling system motorized hinge with a dual clutch.

In accordance with the present invention, a system and method are provided which substantially reduce the disadvantages and problems associated with previous methods and systems for rotating information handling system housing portions with a motorized hinge. A hinge axle rotationally couples housing portions through a clutch having a compressive mechanism and a clamping mechanism to generate torque that resists housing portion rotation. For instance, a clutch housing interior keys clamping clips around an axle and has compressive washers at opposing sides of the clutch housing to generate torque normal the axle as the clutch housing rotates about the axle.

More specifically, a portable information handling system processes information with processing components disposed in a portable housing, such as processor and memory. The portable housing has first and second housing portions rotationally coupled by a motorized hinge that automatically rotates the housing portions relative to each other about an axle disposed at one side of the housing portions. A clutch hinge at an opposite side of the housing interfaces the housing portions through a clutch that provides torque in resistance to housing portion rotation about an axle. The clutch includes a compressive mechanism that provides friction normal the axle and a clamping mechanism that provides friction with a gripping force around the axle. For example a clutch housing interior accepts C-clips keyed to an orientation and aligned to fit over the axle. Washers inserted over the axle on both sides of the clutch housing are compressed against the clutch housing to resist rotation relative to the axle. By relying on the clamping mechanism for a greater part of the torque, such as 70% to 90%, the clutch mechanism has reduced degradation in torque over time, and the compressive mechanism offers greater precision for dialing in a desired torque level.

The present invention provides a number of important technical advantages. One example of an important technical advantage is that an information handling system portable housing that opens and closes with a motorized hinge has a well-regulated and consistent torque across the housing rotation axis provided by a dual clutch. A rugged clamping mechanism provides enhanced wear at the clutch for reduced torque degradation over time while a compressive mechanism offers more precise torque calibration through an accessible adjustment nut. As a result, manufacture of a portable information handling system having a motorized hinge with a well calibrated and robust torque response is simplified and less expensive. The clutch hinge distributes torque across the housing with the motorized hinge providing rotational force at an opposite side of the housing, allowing a more compact solution and reduced hinge width.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exploded perspective view of an information handling system having a motorized hinge regulated by a clutch hinge;

FIG. 2 depicts a perspective view of the clutch hinge;

FIG. 3 depicts an exploded perspective view of the clutch hinge; and

FIG. 4 depicts an exploded perspective view of the clutch hinge having a counterbalance spring.

### DETAILED DESCRIPTION

A portable information handling system regulates rotation of a motorized hinge with a clutch hinge having compressive and clamping torque mechanisms. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

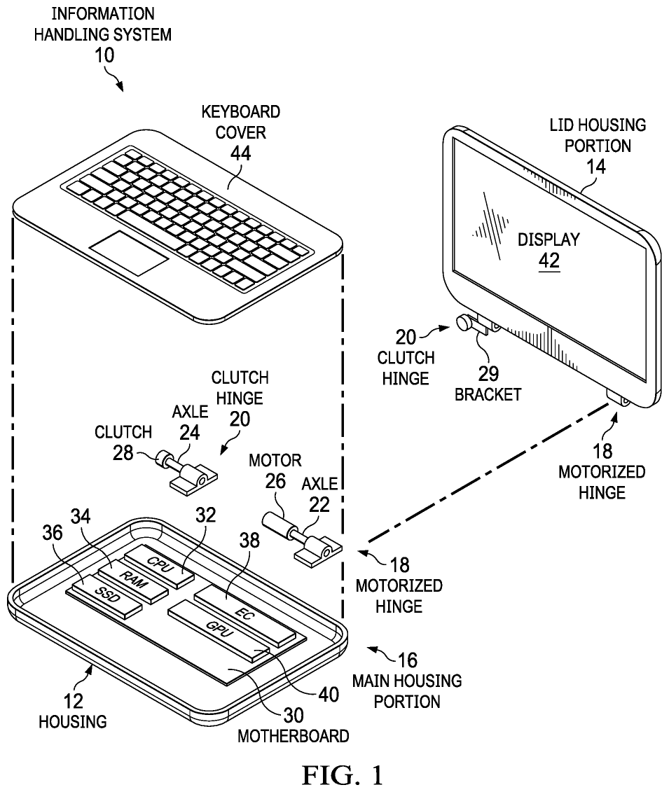

Referring now to FIG. 1, an exploded perspective view depicts an information handling system 10 having a motorized hinge 18 regulated by a clutch hinge 20. In the example embodiment, information handling system 10 processes information with processing components disposed in a portable housing 12. Portable housing 12 has a lid housing portion 14 rotationally coupled with a main housing portion 16 by a motorized hinge 18 on one side of housing 12 and a clutch hinge 20 on the other side of housing 12. Lid housing portion 14 and main housing portion 16 rotate about axle 22 in motorized hinge 18 and axle 24 in clutch hinge 20 aligned along a common rotational axis. A motor 26 coupled to lid housing portion 14 and main housing portion 16 provides rotational movement, such as in response to control and power provided from the processing components. For example, motor 26 is a stepper motor that measures rotational orientation to open housing 12 to a desired position. In addition, end user force applied to lid housing portion 14 allows more precise alignment of the housing orientation with manual movement. Clutch hinge 20 regulates housing orientation with a clutch 28 that generates torque to resist rotation. Torque of clutch 28 translates to lid housing portion 14 through a bracket 29 that couples at one end to clutch 28 and at an opposing end to lid housing portion 14. Substantially matching torque at motorized hinge 18 and clutch hinge 20 provides smooth rotation without generating transverse force across housing 12, and holds lid housing portion 14 in a relative position when rotational force is removed.

In the example embodiment, a motherboard 30 couples to main housing portion 16 to provide communication between processing components that cooperate to process information. For example, a central processing unit (CPU) 32 executes instructions that process information. A random access memory 34 interfaced with CPU 32 stores the instructions and information for access by CPU 32. A solid state drive (SSD) 36 provides non-transient memory that stores an operating system, applications and information during power down states for retrieval to CPU 32 and RAM 34 at power up. An embedded controller 38 manages operating conditions at the system, such as application of power and maintaining thermal constraints. In addition, embedded controller manages inputs from peripheral devices, such as a keyboard and mouse, that are communicated to CPU 32. In the example embodiment, embedded controller provides control and power to motorized hinge 18, such as by commanding an open position at power up and a closed position at power down. A graphics processing unit (GPU) 40 interfaces with CPU 32 to further process information for presentation as visual images at a display 42 integrated in lid housing portion 14, such as by generating pixel values that define visual images. A keyboard cover 44 fits over main housing portion 16 and integrates a keyboard that provides key inputs to embedded controller 38. In alternative embodiments, a second display may be used as a cover for main housing portion 16. The displays may be separate liquid crystal display (LCD) panels or organic light emitting diode (OLED) display panels. One alternative embodiment disposes a flexible OLED display film across both housing portions.

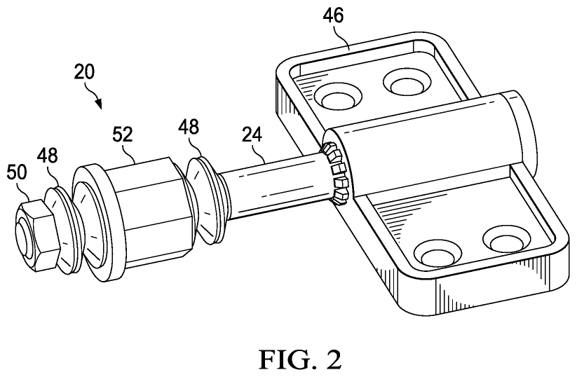

Referring now to FIG. 2, a perspective view depicts clutch hinge 20. A bracket 46 couples in a fixed manner to one of the housing portions, such as by coupling to the main housing portion with screws. Bracket 46 holds axle 24 in a fixed rotational orientation along the same rotational axis as the motorized hinge. A clutch housing 52 fits over the end of axle 24 to generate torque when rotated relative to the fixed rotational orientation of axle 24. A compressive mechanism 48 generates torque against rotation of clutch housing 52 with a compressive force applied by a nut 50 that tightens against clutch housing 52 and generates friction at rotation of clutch housing 52 during rotation relative to axle 24. In the example embodiment, clutch housing 52 is formed as a nut that engages with a bracket coupled to an opposing housing portion, such as the lid housing portion. As described in greater detail below, torque is generated by compressive mechanism 48 and also by a clamping mechanism disposed in the interior of clutch housing 52.

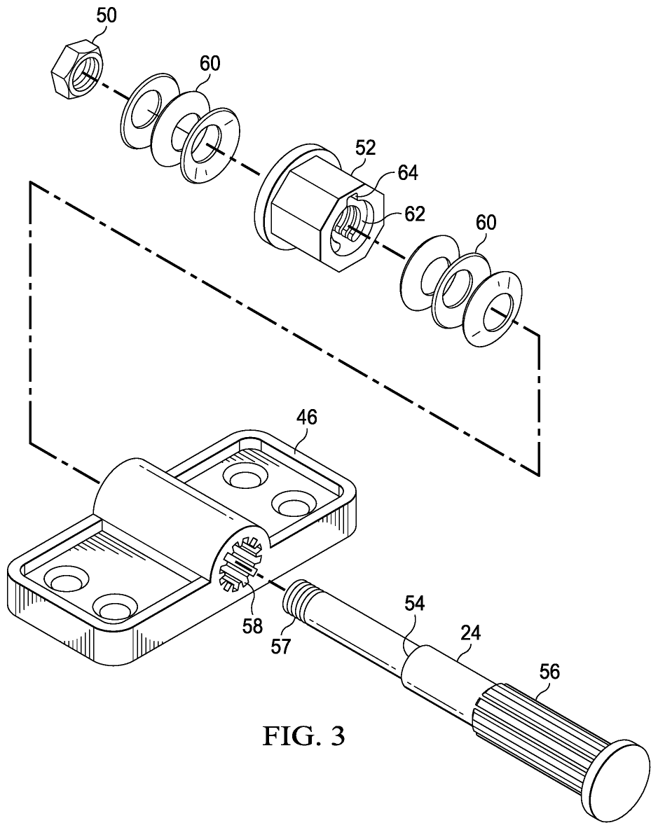

Referring now to FIG. 3, an exploded perspective view depicts clutch hinge 20. Axle 24 terminates at one end with axle splines 56 that fit into bracket splines 58 to hold axle 24 stationary relative to bracket 46. Axle 24 includes a bevel 54 that acts as a stop to hold the compressive mechanism 48 in place during compression by nut 50. Compressive mechanism 48 is made with a set of Belleville washers 60 inserted over axle 24 on both sides of clutch housing 52 and compressed by tightening of nut 50 to compress Belleville washers 60 against bevel 54. Clutch housing 52 is a keyed bushing having an open interior with a key 64 that accepts a clamping mechanism 62, such as a set of C-clips having an extension that fits into key 64 to hold their position relative to clutch housing 52 when it rotates about axle 24 due to a rotational forces translated to clutch housing 52 from a bracket coupled to the opposing housing portion. Axle 24 inserts into the opening defined by the interior circumference of clamping mechanism 62 so that a clamping force is applied that resists rotation of clutch housing 52 relative to axle 24. A clutch is thus defined by a dual torque arrangement that generates torque both at the interior of clutch housing 52 and against the side surface of clutch housing 52 so friction is generated in two different modes within a single assembly for a well-regulated and enduring response.

During manufacture, clutch hinge 20 is calibrated to provide a desired torque by using compression at Belleville washers 60 to tune torque over a fixed torque of clamping mechanisms 62. For example, C-clips are selected that provide 70% to 90% of the torque desired from the clutch. An advantage of using the C-clips to generate the majority of the torque is that clamping torque tends to degrade more slowly with use over time compared with compressive torque. However, clamping torque tends to be more difficult to tune to a desired level as variance between different assemblies may be beyond desired constraints. By supplementing clamping torque with 10% to 30% compressive torque, a more exact calibration of total torque is possible. That is, at manufacture nut 50 is tightened to threads 57 to achieve the desired total torque as an addition to the portion provided by clamping torque. Over the life of the clutch, greater wear on the clamping mechanism relative to the compressive mechanism provides a more reliable torque response with less impact by degradation of the friction surfaces.

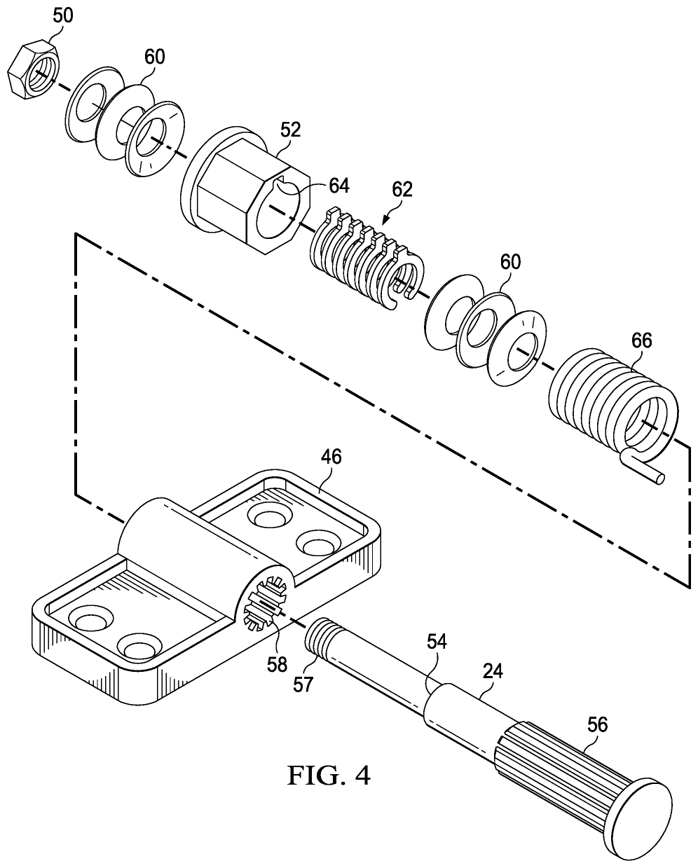

Referring now to FIG. 4, an exploded perspective view depicts the clutch hinge having a counterbalance spring 66. In the example embodiment, counterbalance spring 66 inserts over axle 24 and engages against bracket 46 to store tension when the housings rotate to a closed position and release tension when the housings rotate to an open position. Counterbalance spring 66 helps to offset the weight of the lid housing portion to reduce the load on the motor when rotating the lid housing portion to an upward position. In the example embodiment, clamping mechanism 62 is exploded out of clutch housing 52 to illustrate that plural keyed C-clips insert into clutch housing 52 to generate torque. The amount of torque provided by this clamping mechanism may be varied by selecting different numbers of C-clips and the amount of compression provided by each.

Although the present invention has been described in detail, it should be understood that various changes, substitutions and alterations can be made hereto without departing from the spirit and scope of the invention as defined by the appended claims.

What is claimed is:

1. An information handling system comprising:
a housing having first and second housing portions;
processing components disposed in the housing and operable to process information;
a display integrated in one of the first or second housing portions and interfaced with the processing components, the display operable to present the information as visual images;
a hinge rotationally coupling the first and second housing portions about an axle;
a motor operable to rotate the first and second housing portions relative to each other; and
a clutch coupled to the axle to generate torque that resists rotation of the first and second housing portions relative to each other, the clutch having a compressive mechanism providing a gripping force normal the axle and a clamping mechanism providing a gripping force clamping around the axle.

2. The information handling system of claim 1 wherein the clutch further comprises:
a clutch housing disposed around the axle;
wherein the compressive mechanism comprises washers inserted over the axle at opposing sides of the clutch housing; and
wherein the clamping mechanism comprises clips disposed in an interior of the clutch housing and disposed around the axle.

3. The information handling system of claim 2 wherein the axle terminates with threads and a nut that tightens at the threads compress the washers.

4. The information handling system of claim 2 further comprising a counter balance spring disposed around the axle to store tension when the housing rotates to a closed position and release the tension when the housing rotates to an open position to reduce load on the motor when rotating the housing to the open position.

5. The information handling system of claim 2 wherein the clutch housing interior forms a keyed position and the clips have a key that fits into the keyed position to maintain the clip position relative to the clutch housing.

6. The information handling system of claim 5 wherein the clamping mechanism provides at least 70% of a total gripping force of the clutch and the compressive mechanism provides no more than 30% of the total gripping force.

7. The information handling system of claim 5 wherein the hinge further comprises:
a bracket fixedly coupled to the first housing portion, the bracket having an opening with bracket splines disposed in the opening interior;
axle splines integrated in one end of the axle to engage the bracket splines and fix the axle relative to the bracket; and
a coupling member engaging the second housing portion and the clutch housing.

8. The information handling system of claim 7 wherein:
the hinge is located at one side of housing; and
the motor is located at an opposite side of the housing.

9. The information handling system of claim 8 wherein the motor comprises a stepper motor that tracks the relative position of the first and second hinge portions.

10. A method for rotating information handling system housing first and second housing portions relative to each other, the method comprising:
coupling a motor to a first side of the first and second housing portions at a first hinge having a first axle;
coupling a second hinge at second side of the first housing portion opposite the first side, the second hinge having a second axle;
coupling a clutch to the second axle, the clutch having a compressive mechanism providing a gripping force normal the second axle and a clamping mechanism providing a gripping force clamping around the second axle; and
coupling a bracket to the clutch and the second housing portion, the clutch resisting rotation of the second housing portion about the second axle.

11. The method of claim 10 further comprising:
inserting the clamping mechanism into an interior of a clutch housing of the clutch;
inserting the clutch housing onto the second axle to engage the clamping mechanism with the second axle;
inserting the compressive mechanism onto the second axle on both sides of the clutch housing; and
tightening a nut at threads located at the end of the axle to compress the compressive mechanism against the clutch housing.

12. The method of claim 11 further comprising:
aligning an extension of the clamping mechanism with a key formed in the interior of the clutch housing; and
holding the clamping mechanism in position relative to the clutch housing during rotation of the clutch relative to the second axle by engagement of the extension in the key.

13. The method of claim 12 wherein the clamping mechanism comprises plural C-clips that clamp around the second axle.

14. The method of claim 11 wherein the compressive mechanism comprises washers.

15. The method of claim 11 further comprising:
generating at least 70 percent of a total torque resisting rotation with the gripping force; and
calibrating the total torque resisting rotation by adjusting a tightness of the nut compressing the compressive mechanism.

16. The method of claim 10 further comprising:
coupling a counterbalance spring to the second axle;
building tension in the counterbalance spring during rotating of the first and second housing portions to a closed position; and
releasing the tension of the counterbalance spring during rotating of the first and second housing portions to an open position, the releasing tension aiding the motor to rotate to the open position.

17. A hinge comprising:
a bracket configured to couple to a first housing portion;
an axle extending from the bracket; and
a clutch coupled to the axle to generate torque that resists rotation of the clutch relative to the axle, the clutch having a compressive mechanism providing a gripping force normal the axle and a clamping mechanism providing a gripping force clamping around the axle.

18. The hinge of claim 17 further comprising a clutch bracket coupled to the clutch at a first end and configured to couple to a second housing portion at a second end, the clutch resisting rotation of the second housing portion relative to the first housing portion about the axle.

19. The hinge of claim 17 wherein the clutch clamping mechanism further comprises:
a clutch housing having an interior with a key; and
plural C-clips inserted in the interior and engaged with the axle, each C-clip having an extension that fits in the key to hold the C-clip in position relative to the clutch housing.

20. The hinge of claim 19 wherein the compression mechanism further comprises:
plural washers inserted on the axle at opposing sides of the clutch housing; and
a nut coupled to threads at an end of the axle, the nut tightening to compress the plural washers against the clutch housing.
